(19) United States
(12) Patent Application Publication
(10) Pub. No.: US 2026/0151801 A1
(43) Pub. Date: Jun. 4, 2026

(54) SUBSTRATE CLEANING APPARATUS AND SUBSTRATE POLISHING APPARATUS

(71) Applicant: EBARA CORPORATION, Tokyo (JP)

(72) Inventors: HARUKI KAGAWA, Tokyo (JP); ERINA BABA, Tokyo (JP); KOHEI SATO, Tokyo (JP); AKIRA IMAMURA, Tokyo (JP)

(73) Assignee: EBARA CORPORATION, Tokyo (JP)

(21) Appl. No.: 19/403,223

(22) Filed: Nov. 27, 2025

(30) Foreign Application Priority Data
Nov. 29, 2024 (JP) 2024-208679

(51) Int. Cl. B08B 3/02; B08B 13/00

(52) U.S. Cl. CPC B08B 3/02; B08B 13/00; B08B 2203/02

(57) ABSTRACT

A substrate cleaning apparatus includes: first and second cleaning units including first and second cleaning nozzles spraying cleaning solutions toward a substrate at a cleaning position, respectively, the second cleaning nozzle having a smaller spray port diameter; first and second valves switching between spraying and not spraying the cleaning solution from the first cleaning nozzle and between spraying and not spraying the cleaning solution from the second cleaning nozzle, respectively; and a control unit controlling the first and second valves to spray the cleaning solutions from the respective cleaning units. The control unit executes first self-cleaning where the cleaning solution exits from the first valve and second self-cleaning in which the cleaning solution exits from the second valve when the substrate is not at the cleaning position, and executes the first self-cleaning before the second self-cleaning.

### CROSS-REFERENCE TO RELATED APPLICATION

This application claims the priority benefit of Japan application serial no. 2024-208679, filed on Nov. 29, 2024. The entirety of the above-mentioned patent application is hereby incorporated by reference herein and made a part of this specification.

### BACKGROUND

### Technical Field

The disclosure relates to an apparatus for cleaning a substrate, such as a semiconductor wafer, and a substrate polishing apparatus including the cleaning apparatus.

### Description of Related Art

A polishing apparatus for polishing a surface of a substrate such as a semiconductor wafer includes a polishing module, a cleaning module, and a substrate transfer mechanism. The polishing module includes a polishing table having a polishing pad and a polishing head (top ring) that holds the substrate. The polishing head transfers the substrate between a deliver position where the substrate is delivered and a polishing position where the substrate overlaps the polishing pad. At the polishing position, the substrate surface is pressed against the polishing pad at a predetermined pressure, and the polishing pad and the substrate are moved relative to each other while a polishing solution (slurry) is supplied, thereby bringing the substrate into sliding contact with the polishing pad to polish the substrate surface to a predetermined film thickness.

The cleaning module includes multiple cleaning modules that perform rough cleaning (primary cleaning) and finish cleaning (secondary cleaning) of the substrate surface, and removes polishing residues (particles) such as polishing solution and polishing debris remaining on the substrate after the polishing process. The cleaning module includes multiple cleaning lines for cleaning multiple substrates (see Patent Document 1).

In the case where particles remain on the substrate surface after the polishing process, the yield of semiconductor devices may be affected. Therefore, it may be desirable to remove the particles before the substrate is transferred to the cleaning module. Accordingly, a polishing apparatus has also been disclosed in which a cleaning process is performed on the substrate after the polishing process by rotating the substrate held by the top ring at a cleaning position provided on a side of the polishing table in the polishing module while spraying a cleaning solution from multiple cleaning nozzles provided below the substrate (see Patent Document 2).

### PRIOR ART DOCUMENT(S)

### Patent Document(s)

[Patent Document 1] Japanese Laid-open Publication No. 2010-50436
[Patent Document 2] Japanese U.S. Pat. No. 6,055,648

In the case of performing a cleaning process by spraying a cleaning solution from multiple cleaning nozzles provided below the substrate, the cleaning nozzles are directed upward, so the cleaning solution or polishing solution dripping from the substrate during cleaning may enter the interior via the spray ports of the nozzles. For this reason, the cleaning solution is sprayed from the cleaning nozzles in a state where no substrate is present above the cleaning nozzles (during polishing or during transfer), thereby cleaning the spray ports of the nozzles (self-cleaning).

The cleaning nozzles include a first cleaning nozzle having a large spray port area and a second cleaning nozzle having a spray port area smaller than that of the first nozzle. The multiple nozzles are each connected to a common pump via corresponding valves, and the spray of cleaning solution from the cleaning nozzles stops by closing the valves after substrate cleaning completes.

At this time, a certain water pressure is generated in the path of the cleaning solution from the pump to the valves, and in the case where all valves are opened to start self-cleaning in such state, the cleaning solution may be sprayed vigorously from the second cleaning nozzle having whose spray port has a smaller area, and the cleaning solution may adhere to the housing near the cleaning position or to other cleaning nozzles. In particular, immediately after substrate cleaning, the polishing solution adheres to the cleaning nozzles. Therefore, when the cleaning solution containing the polishing solution is vigorously sprayed during self-cleaning, the vicinity of the cleaning nozzles may become contaminated, and the cleaning effect immediately after substrate polishing may be affected.

The disclosure provides a substrate cleaning apparatus and a substrate polishing apparatus capable of performing self-cleaning efficiently by suppressing vigorous spray of a cleaning solution containing polishing solution during self-cleaning.

### SUMMARY

According to an aspect of the invention, a substrate cleaning apparatus that cleans a substrate at a cleaning position after the substrate is polished. The substrate cleaning apparatus includes: a first cleaning unit, including a first cleaning nozzle that sprays a cleaning solution toward the substrate that is at the cleaning position; a second cleaning unit, including a second nozzle that is a second cleaning nozzle spraying a cleaning solution toward the substrate at the cleaning position and has a spray port whose diameter is smaller than a diameter of a spray port of the first cleaning nozzle; a first valve, switching between a first open state in which the cleaning solution is sprayed from the first cleaning nozzle and a first closed state in which the cleaning solution is not sprayed from the first cleaning nozzle; a second valve, switching between a second open state in which the cleaning solution is sprayed from the second cleaning nozzle and a second closed state in which the cleaning solution is not sprayed from the second cleaning nozzle; and a control part, controlling the first valve and the second valve, so as to spray the cleaning solution from each of the first cleaning unit and the second cleaning unit. The control part is configured to: control an operation of the first valve, so that first self-cleaning is executed in which the cleaning solution exits from the first valve by switching the first cleaning nozzle from the first closed state to the first open state in a state where the substrate is not at the cleaning position; control an operation of the second valve, so that second self-cleaning is executed in which the cleaning solution exits from the second valve by switching the second cleaning nozzle from the second closed state to the second open state in the state where the substrate is not at the cleaning position; and exert control to execute the first self-cleaning prior to the second self-cleaning.

An aspect of the disclosure has a configuration that is a substrate polishing device and includes a polishing table, a top ring, and the substrate cleaning device.

### Inventive Effects

According to the disclosure, self-cleaning can be performed efficiently by suppressing vigorous spray of a cleaning solution containing polishing solution during self-cleaning.

### BRIEF DESCRIPTION OF THE DRAWINGS

FIG. 1 is a plan view showing a schematic configuration of a substrate polishing apparatus including a substrate cleaning apparatus according to an embodiment of the disclosure.

FIG. 2 is a plan view showing a configuration of a polishing unit.

FIG. 3 is a perspective view of the polishing unit of FIG. 2.

FIG. 4 is a schematic cross-sectional view showing an internal configuration of a top ring.

FIG. 5 is a plan view describing how the substrate moves among a deliver position, a cleaning position, and a polishing position.

FIG. 6 is a plan view showing a configuration of an auxiliary cleaning part.

FIG. 7 is a plan view showing a configuration of the auxiliary cleaning part, illustrating a state in which cleaning solution is sprayed from nozzles constituting the first cleaning unit and the second cleaning unit.

FIG. 8 is an explanatory diagram showing an overview of a mechanism for supplying cleaning solution to the first cleaning unit and the second cleaning unit.

FIG. 9 is a functional block diagram showing a configuration of a substrate polishing apparatus.

FIG. 10 is a flowchart showing a procedure for a substrate polishing and cleaning process.

FIG. 11 is a flowchart showing a procedure for self-cleaning.

FIG. 12 is a flowchart showing an example of operations of the first cleaning unit and the second cleaning unit during self-cleaning.

### DESCRIPTION OF THE EMBODIMENTS

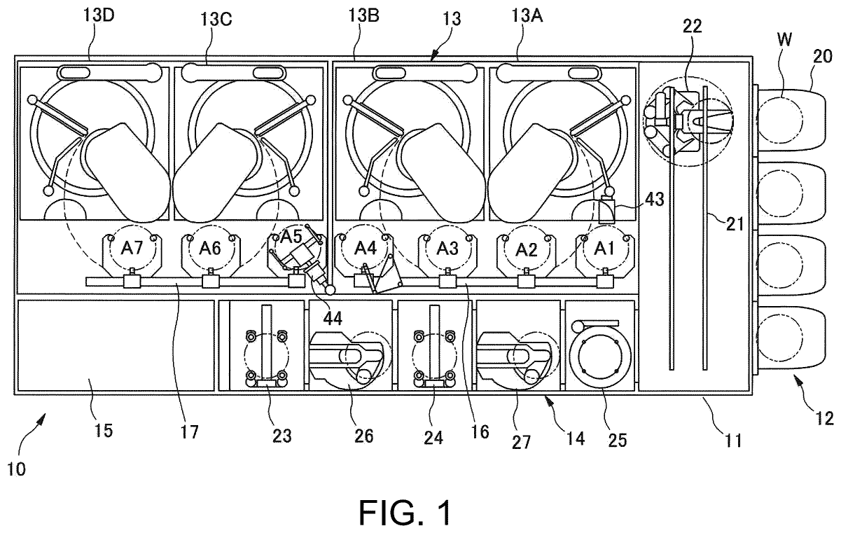

Hereinafter, embodiments of the disclosure will be described with reference to the drawings. FIG. 1 schematically shows a configuration of a substrate polishing apparatus including a substrate cleaning apparatus according to the embodiment. The substrate polishing apparatus 10 includes a rectangular housing 11 and is partitioned by partition walls into a load/unload part 12, a polishing part 13, and a cleaning part 14. The substrate polishing apparatus 10 also includes a control part 15 that controls the operations of respective parts.

The load/unload part 12 includes multiple front load parts where substrate cassettes 20 that accommodate several substrates W such as semiconductor wafers are set. In the load/unload part 12, a traveling mechanism 21 is installed along the arrangement of the substrate cassettes 20, and a transfer robot 22 that can move along the arrangement direction of the substrate cassettes 20 is installed on the traveling mechanism 21. The transfer robot 22 receives unpolished substrates W from the substrate cassettes 20 and transfers the substrates W toward the polishing part 13, and receives polished/cleaned substrates W from the cleaning part 14.

The polishing part 13 includes multiple polishing units 13A to 13D for polishing (planarizing) the substrates W. The first polishing unit 13A to fourth polishing unit 13D are arranged along the longitudinal direction of the substrate polishing apparatus 10. Details of the configuration of the polishing units will be described later.

A first linear transporter 16 is disposed adjacent to the first polishing unit 13A and the second polishing unit 13B. The first linear transporter 16 transfers the substrate W among four transfer positions (first transfer position A1 to fourth transfer position A4 in order from the side of the load/unload part 12) along the direction in which the polishing units 13A and 13B are arranged.

A second linear transporter 17 is disposed adjacent to the third polishing unit 13C and the fourth polishing unit 13D. The second linear transporter 17 transfers the substrates W among three transfer positions (fifth transfer position A5 to seventh transfer position A7 in order from the side of the load/unload part 12) along the direction in which the polishing units 13C and 13D are arranged.

The cleaning part 14 accommodates a first cleaning unit 23 and a second cleaning unit 24 that clean the polished substrates W, and a drying unit 25 that dries the cleaned substrates W. A first transfer unit 26 that delivers the substrates W between the first cleaning unit 23 and the second cleaning unit 24 is disposed between the first cleaning unit 23 and the second cleaning unit 24. A second transfer unit 27 that delivers the substrates W between the second cleaning unit 24 and the drying unit 25 is disposed between the second cleaning unit 24 and the drying unit 25.

Inside the first cleaning unit 23, multiple (for example, two) primary cleaning modules are arranged in the upper-lower direction. Similarly, inside the second cleaning unit 24, multiple (for example, two) secondary cleaning modules are arranged vertically. The primary cleaning modules and the secondary cleaning modules are cleaning machines that clean the substrates by using cleaning solutions, and for example, roll sponge type cleaning machines can be used.

Inside the drying unit 25, multiple (for example, two) drying modules are arranged in the upper-lower direction, and the substrates W are dried by spraying gas from nozzles (not shown) toward the substrates W that are rotating. Alternatively, the substrates W may be dried by making use of centrifugal force through rotating the substrates W at a high speed. The transfer robot 22 takes out the cleaned and dried substrates W from the drying unit 25 and returns the substrates W to the substrate cassettes 20.

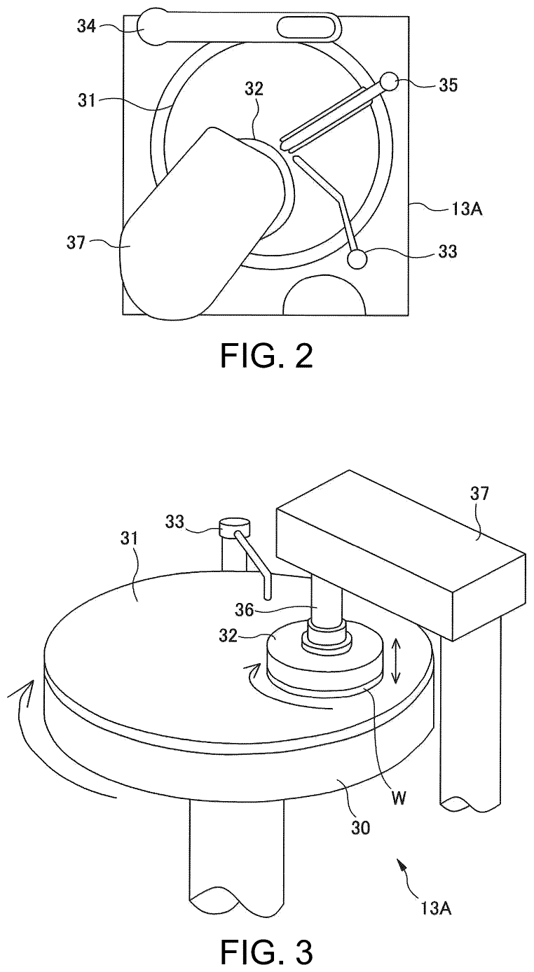

FIG. 2 and FIG. 3 show a schematic configuration of the first polishing unit 13A according to the embodiment. Since the second polishing unit 13B to the fourth polishing unit 13D have the same configuration as the first polishing unit 13A, the first polishing unit 13A will be described below.

The first polishing unit 13A includes: a polishing table 30 to which a polishing pad 31 having a polishing surface is attached; a top ring 32 for polishing by holding the substrate W while pressing the substrate W against the polishing pad 31 on the polishing table 30 at a predetermined pressure; a polishing solution supply nozzle 33 for supplying a polishing solution or dressing solution (for example, pure water) to the polishing pad 31; a dresser 34 for dressing the polishing surface of the polishing pad 31; and an atomizer 35 that sprays a mixed fluid of liquid (for example, pure water) and gas (for example, nitrogen gas) or liquid (for example, pure water) in a mist form onto the polishing surface. The top ring 32 is configured to be rotatable by a swing arm 37 connected via a top ring shaft 36.

The polishing pad 31 attached on the polishing table 30 forms a polishing surface for polishing the substrate W. In place of the polishing pad 31, fixed abrasive grains can also be used. The top ring 32 and the polishing table 30 are configured to rotate around the axes thereof (see arrows in FIG. 3). The substrate W is held on the lower surface of the top ring 32 by vacuum suction. The polishing solution is supplied from the polishing solution supply nozzle 33 to the upper surface (polishing surface) of the polishing pad 31, and the substrate W is pressed against the polishing pad 31 by the top ring 32 and polished.

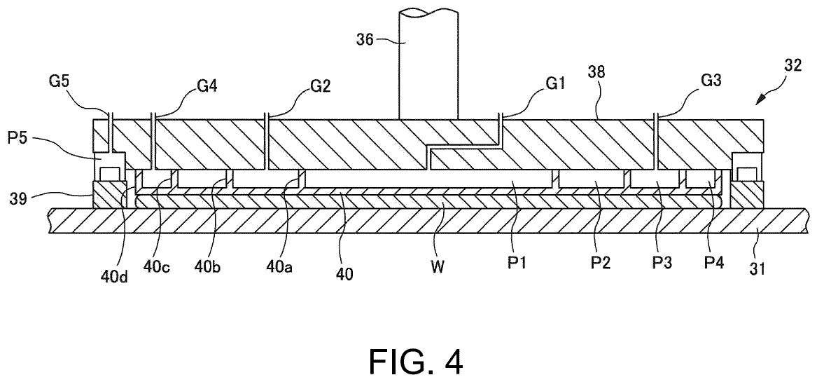

In FIG. 4, the top ring 32 is connected to the lower end of the top ring shaft 36 via a universal joint (not shown) that is a ball joint. The top ring 32 includes a substantially disk-shaped top ring body 38, a retainer ring 39 disposed at a lower portion of the top ring body 38, and a circular membrane (elastic pad) 40 that contacts the substrate W. The top ring body 38 is formed from a material with high strength and rigidity such as metal or ceramics. The retainer ring 39 is formed from a highly rigid resin material or ceramics.

The membrane 40 is attached to the lower surface of the top ring body 38. Between the membrane 40 and the top ring body 38, multiple pressure chambers (air bags) P1, P2, P3, P4 are formed by multiple partition walls 40a to 40d formed in the membrane 40. Pressurized fluid such as pressurized air is supplied to the pressure chambers P1, P2, P3, P4 via fluid paths G1, G2, G3, G4, respectively, or vacuum is applied. The central pressure chamber P1 is circular, and other pressure chambers P2, P3, P4 are annular, and the pressure chambers P1, P2, P3, P4 are arranged concentrically.

The internal pressures of the pressure chambers P1, P2, P3, P4 can be changed independently of each other by a pressure adjustment part (not shown). Accordingly, the pressing forces on four regions of the substrate W, namely, the central portion, the inner intermediate portion, the outer intermediate portion, and the peripheral portion, can be adjusted independently.

To prevent the substrate W that is being polished from flying out from the top ring 32, the outer peripheral portion of the substrate W is held in a state of being surrounded by the retainer ring 39 provided on the lower surface of the top ring 32. An opening is formed in a portion of the membrane 40 that forms the pressure chamber P3, and by forming vacuum in the pressure chamber P3, the substrate W is sucked and held to the top ring 32. By supplying nitrogen gas, dry air, compressed air, or the like to the pressure chamber P3, the substrate W is released from the top ring 32.

Between the retainer ring 39 and the top ring body 38, an elastic bag forming a pressure chamber P5 is disposed. The retainer ring 39 can move up and down relative to the top ring body 38. A fluid path G5 communicates with the pressure chamber P5, and pressurized fluid such as pressurized air is supplied to the pressure chamber P5 through the fluid path G5. The internal pressure of the pressure chamber P5 can be adjusted by the pressure adjustment part, and the pressing force of the retainer ring 39 against the polishing pad 31 can be adjusted independently of the pressing force on the substrate W.

The substrate W may be polished by any one of the first polishing unit 13A, the second polishing unit 13B, the third polishing unit 13C, and the fourth polishing unit 13D, or may be continuously polished by multiple polishing units selected in advance from the polishing units 13A to 13D. By leveling the polishing times of all the polishing units 13A to 13D, the throughput can be improved.

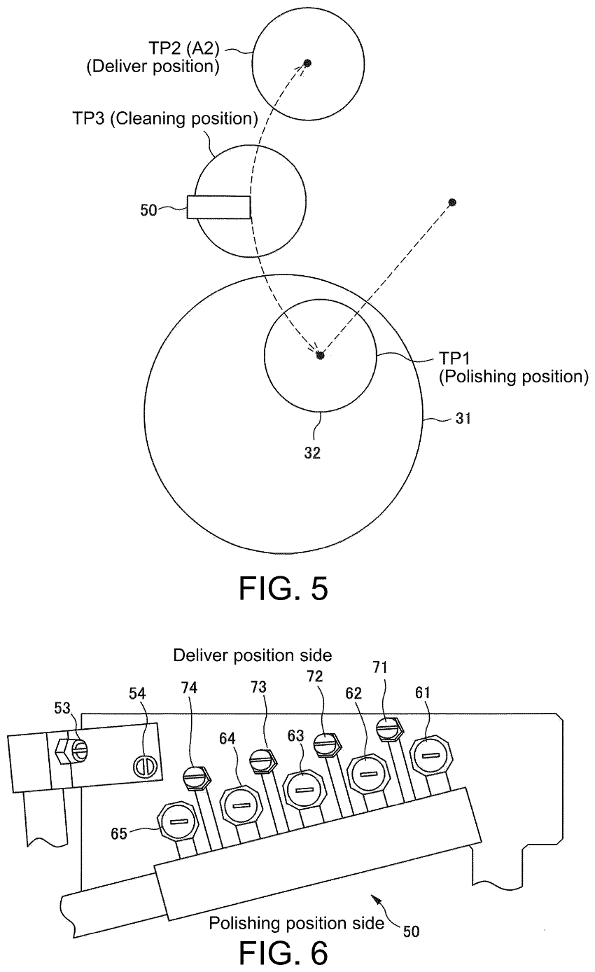

In FIG. 1, the substrate W is transferred to the polishing units 13A and 13B by using the first linear transporter 16. The top ring 32 of the first polishing unit 13A moves between a polishing position above the polishing table 30 (reference numeral omitted in FIG. 5, polishing pad 31) and a second transfer position A2 lateral to the polishing table 30. The delivery of the substrate to the top ring 32 is performed at the second transfer position A2, and the second transfer position A2 becomes a deliver position TP2 (see FIG. 5).

Similarly, the top ring of the second polishing unit 13B (third polishing unit 13C, fourth polishing unit 13D) moves between the polishing position above the polishing table (polishing pad) and a third transfer position A3 (sixth transfer position A6 for the third polishing unit 13C; seventh transfer position A7 for the fourth polishing unit 13D) lateral to the polishing table, and the delivery of the substrate to the top ring is performed at the third transfer position A3 (sixth transfer position A6, seventh transfer position A7) as the substrate delivery position.

A lifter 43 for receiving a substrate from the transport robot 22 is disposed at the first transport position A1. The substrate is transferred from the transport robot 22 to the first linear transporter 16 via the lifter 43. Additionally, a swing transporter 44 having a reversing function is disposed among the first linear transporter 16, the second linear transporter 17, and the cleaning part 14, and performs delivery of the substrate from the first linear transporter 16 to the second linear transporter 17 and transport of the substrate from the polishing part 13 to the cleaning part 14.

FIG. 5 shows a schematic illustration of the positional relationship among the polishing table 30 (polishing pad 31, reference numeral omitted in FIG. 5), the top ring 32, and the auxiliary cleaning part 50 of the first polishing unit 13A. The top ring 32 is made rotatable by a swing arm 37 connected via a top ring shaft 36, and is configured to move between a polishing position TP1 above the polishing table 31, the deliver position TP2 (second transport position A2) lateral to the polishing table 30A, and a cleaning position TP3 between the polishing position TP1 and the deliver position TP2. The auxiliary cleaning part 50 is disposed at a position corresponding to the cleaning position TP3 of the top ring 32.

The configuration of the top ring 32 and the auxiliary cleaning part 50 is similar in the second polishing unit 13B to the fourth polishing unit 13D, and detailed description is omitted. The auxiliary cleaning part 50 may be provided in all of the first polishing unit 13A to the fourth polishing unit 13D, or the auxiliary cleaning part 50 may be omitted in one or more of the polishing units.

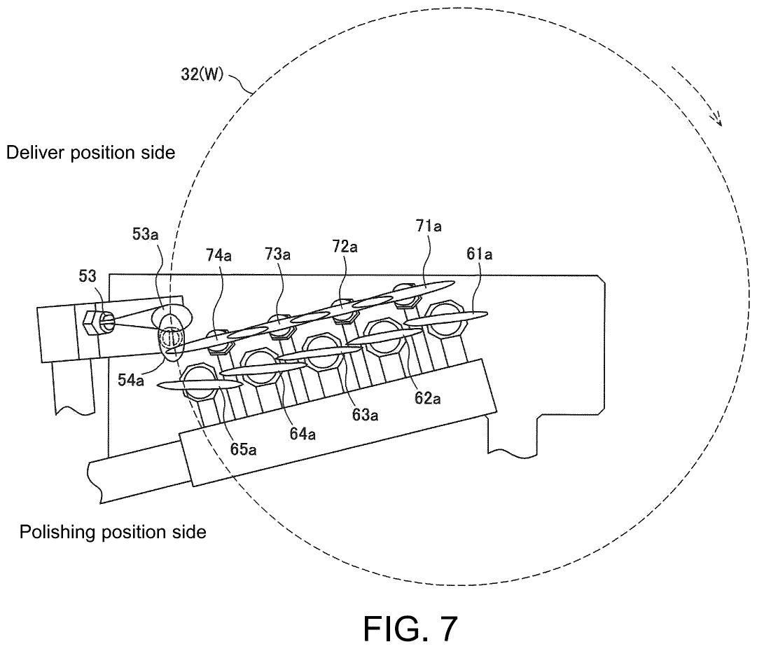

FIG. 6 and FIG. 7 are plan views showing the configuration of the auxiliary cleaning part 50. The auxiliary cleaning part 50 includes a first cleaning unit 51, a second cleaning unit 52, a retainer ring (RR) side surface cleaning nozzle 53, and an RR/membrane cleaning nozzle 54. The first cleaning unit 51 includes multiple (five in this embodiment) substrate cleaning nozzles 61 to 65. The second cleaning unit includes multiple (four in this embodiment) assist nozzles 71 to 74. The auxiliary cleaning part 50 performs a cleaning process on the polished substrate W at the cleaning position TP3 and the top ring 32 holding the substrate W. By performing the cleaning process before the polished substrate W is transported to the cleaning part 14, particles remaining on the surface of the substrate W can be effectively removed.

The substrate cleaning nozzles 61 to 65 forming the first cleaning unit 51 are, for example, two-fluid nozzles, and are cleaning machines that mix liquid and gas and spray the mixed fluid (cleaning solution) onto the surface of the substrate, and can remove minute particles on the substrate by using minute droplets and impact energy. The substrate cleaning nozzles 61 to 65 are arranged linearly along the radial direction on the lower side of the top ring 32 when the top ring 32 is at the cleaning position TP3. The substrate cleaning nozzles 61 to 65 spray the cleaning solution vertically upward from the lower side of the substrate W onto the surface of the substrate W that rotates together with the top ring 32 in the arrow direction of FIG. 7 at the cleaning position TP3.

The substrate cleaning nozzles 61 to 65 can be selected from those that perform pressurized injection of a mixed fluid (two-fluid) of liquid (such as pure water) and gas, those that perform high-speed jet injection, and those that apply ultrasonic waves. As liquid types supplied to the substrate cleaning nozzles 61 to 65, for example, pure water, acidic or alkaline chemical solutions or surfactants, liquids containing minute amounts of carbon dioxide for suppressing static electricity, N₂ gas-saturated water, and fine bubble-containing water can be used.

As shown in FIG. 7, in the first cleaning unit 51, the first substrate cleaning nozzle 61 provided on one end side (rear side) is disposed at a position corresponding to the vicinity of the center of the top ring 32, and the fifth substrate cleaning nozzle 65 provided on the other end side (front side) is disposed at a position corresponding to the vicinity of the outer peripheral portion of the top ring 32. The shapes of the cleaning solutions sprayed from the respective substrate cleaning nozzles 61 to 65 are elongated substantially elliptical shapes 61a to 65a, respectively, and the major axes thereof are slightly inclined from the radial direction of the top ring 32 and are configured not to overlap with each other. Accordingly, in the case where the top ring 32 rotates, a flow of the cleaning solution toward the outer peripheral portion of the top ring 32 (substrate W) is formed along the rotation direction of the top ring 32, and the cleaning solution is easily spread over the entire surface of the substrate W. The flow along the rotation direction of the top ring 32 becomes a fast flow due to centrifugal force caused by the rotation of the top ring 32, and the cleaning solution containing particles such as abrasives is easily discharged to the outside from the outer peripheral edge of the substrate W.

The retainer ring (RR) side surface cleaning nozzle 53 is disposed below the top ring 32 positioned at the cleaning position TP3, and sprays a cleaning solution 53a in an oblique upward direction toward the side surface and the bottom surface of the retainer ring 39 in a state where the top ring 32 rotates at the cleaning position TP3. Accordingly, particles adhering to the side surface of the retainer ring 39 after the polishing process can be removed.

In addition, the RR/membrane cleaning nozzle 54 is disposed below the top ring 32 positioned at the cleaning position TP3, and sprays a cleaning solution 54a in a vertically upward direction toward the boundary portion between the retainer ring 39 and the membrane 40 in a state where the top ring 32 rotates at the cleaning position TP3. Accordingly, particles adhering to the gap between the retainer ring 39 and the membrane 40 after the polishing process can be removed.

Here, due to the spray of the cleaning solutions from the retainer ring (RR) side surface cleaning nozzle 53 and the RR/membrane cleaning nozzle 54, particles adhering to the retainer ring 39 and the membrane 40 may be scattered toward the substrate W held by the top ring 32. For this reason, the spray stop timings of the cleaning solutions from the retainer ring (RR) side surface cleaning nozzle 53 and the RR/membrane cleaning nozzle 54 are controlled to be simultaneous with or earlier than the spray stop timings of the cleaning solutions from the substrate cleaning nozzles 61 to 65. Even in the case where particles adhering to the retainer ring 39 and the membrane 40 are scattered to the substrate W, the particles can be removed by spray of the cleaning solution from the substrate cleaning nozzles 61 to 65.

In FIG. 6 and FIG. 7, the assist nozzles 71 to 74 that form the second spray unit for assisting in substrate cleaning are single-fluid nozzles that spray cleaning solutions onto the surface of the substrate, and are arranged linearly on the lower side of the top ring 32 when the top ring 32 is at the cleaning position TP3. The assist nozzles 71 to 74 can be selected from spray nozzles (for example, single-fluid nozzles that spread in a fan shape), high-speed jet injection nozzles, and nozzles that apply ultrasonic waves. As liquid types supplied to the assist nozzles 71 to 74, for example, pure water, acidic or alkaline chemical solutions or surfactants, liquids containing a minute amount of carbon dioxide for suppressing static electricity, N₂ gas-saturated water, and fine bubble containing water can be used.

The assist nozzles 71 to 74 spray substantially elliptical cleaning solutions (for example, pure water) 71a to 74a (see FIG. 7) in a vertically upward direction onto the surface of the substrate W that rotates together with the top ring 32 in the arrow direction of FIG. 7 at the cleaning position TP3. The assist nozzles 71 to 74 are arranged such that the sprayed cleaning solutions 71a to 74a overlap with each other, and the cleaning solutions 71a to 74a sprayed from all of the assist nozzles 71 to 74 are integrated to form one linear cleaning solution.

The cleaning solutions sprayed from the assist nozzles 71 to 74 onto the substrate W move toward the outer periphery of the substrate W due to the centrifugal force through the rotation of the top ring 32. In the embodiment, the spray positions of the cleaning solutions onto the substrate W by the assist nozzles 71 to 74 are downstream of the spray positions of the cleaning solutions by the substrate cleaning nozzles 61 to 65 with respect to the rotation direction of the top ring 32 (see FIG. 7). This makes it easier for the cleaning solutions sprayed from the substrate cleaning nozzles 61 to 65 onto the substrate W to move toward the outer peripheral portion of the substrate W together with the cleaning solution from the assist nozzles 71 to 74, and particle discharge performance is improved.

Additionally, the cleaning solutions sprayed from the assist nozzles 71 to 74 form linear patterns that include the vicinity of the center of the top ring 32. Therefore, as the top ring 32 rotates, liquid can be adhered over a wide range including the central part of the substrate W supported by the top ring 32, and drying of the substrate W can be effectively prevented.

During the cleaning process of the substrate W, the timings for stopping the spray of the cleaning solutions from the assist nozzles 71 to 74 are preferably after stopping the spray of the cleaning solutions from the substrate cleaning nozzles 61 to 65, the retainer ring (RR) side surface cleaning nozzle 53, and the RR/membrane cleaning nozzle 54. This allows the cleaning solutions adhered to the substrate W by the substrate cleaning nozzles 61 to 65, the retainer ring (RR) side surface cleaning nozzle 53, and the RR/membrane cleaning nozzle 54 to be washed away.

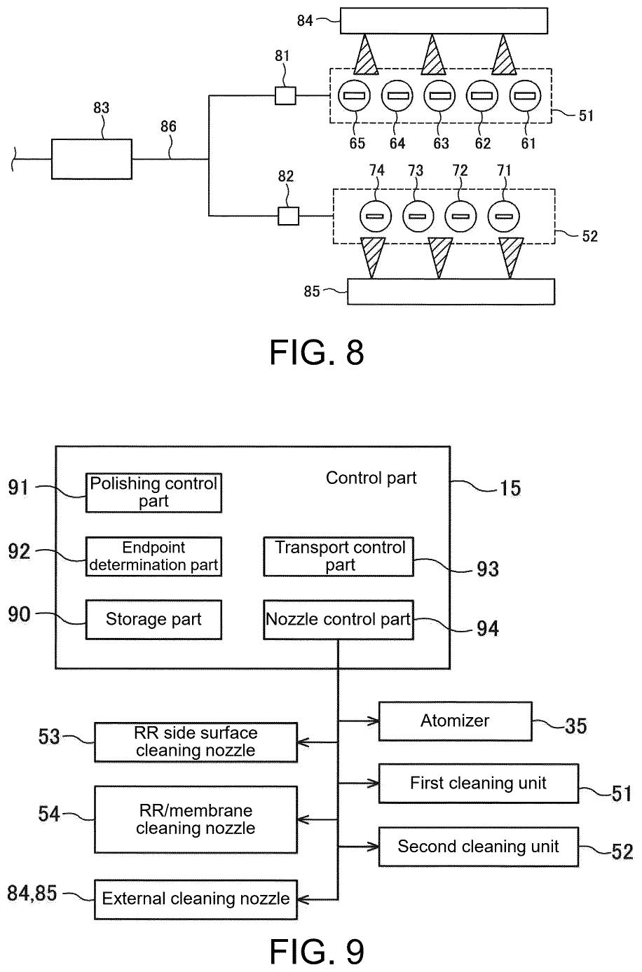

FIG. 8 is an explanatory diagram showing an overview of a mechanism for supplying the cleaning solution to the first cleaning unit 51 and the second cleaning unit 52. The first cleaning unit 51 and the second cleaning unit 52 are respectively connected to a common piping 86 via a first valve 81 and a second valve 82, and the piping 86 is connected to a flow controller (flow rate control device) 83. The flow controller 83 is connected to a cleaning solution supply source (not shown) and supplies the cleaning solution to the first cleaning unit 51 and the second cleaning unit 52.

The first valve 81 and the second valve 82 are open/close type electromagnetic valves, and are configured to be independently turned on and off by control signals from a nozzle control part 94 of the control part 15 described later. When the first valve 81 is opened (first open state), the cleaning solution is supplied from the flow controller 83 to the first cleaning unit 51, and the cleaning solutions are sprayed upward from the substrate cleaning nozzles 61 to 65 toward the back surface of the substrate W at the cleaning position TP3. When the first valve 81 is closed (first closed state), the supply of the cleaning solution from the flow controller 83 to the first cleaning unit 51 stops.

When the second valve 82 is opened (second open state), the cleaning solution is supplied from the flow controller 83 to the second cleaning unit 52, and the cleaning solutions are sprayed upward from the assist nozzles 71 to 74 toward the back surface of the substrate W at the cleaning position TP3. When the second valve 82 is closed (second closed state), the supply of the cleaning solution from the flow controller 83 to the second cleaning unit 52 stops.

Here, the substrate cleaning nozzles 61 to 65 forming the first cleaning unit 51 have larger nozzle diameters (areas of the openings from which the cleaning solutions are sprayed) than the assist nozzles 71 to 74 forming the second cleaning unit 52. This allows improvement of the cleaning effect brought by the first cleaning unit 51, which is a two-fluid nozzle, while suppressing the supply amount of the cleaning solution.

In the case of performing a cleaning process by spraying the cleaning solution from multiple cleaning nozzles provided below the substrate, since the cleaning nozzles face upward, the cleaning solution or the polishing slurry that drips from the substrate during cleaning may enter the interior through the spray ports of the nozzles. Therefore, in the substrate polishing apparatus 10 according to the embodiment, in a state where the substrate W is at a position away from the cleaning position TP3 (that is, in a state where there is no substrate above the auxiliary cleaning part 50), the cleaning solutions are sprayed from the first cleaning unit 51 and the second cleaning unit 52, thereby performing cleaning of the spray ports of the substrate cleaning nozzles 61 to 65 (first self-cleaning) and cleaning of the spray ports of the assist nozzles 71 to 74 (second self-cleaning).

Here, while performing self-cleaning of the first cleaning unit 51 and the second cleaning unit 52, the first valve 81 corresponding to the first cleaning unit 51 having a large nozzle diameter is opened first, and after a certain time has elapsed, the second valve 82 corresponding to the second cleaning unit 52 is opened. In the cleaning process, in the case where a residual pressure (constant water pressure) is generated in the cleaning solution path 86 from the flow controller to the valve due to discharging at a high flow rate from the first cleaning unit 51 and the second cleaning unit 52, the cleaning solutions are sprayed first from the substrate cleaning nozzles 61 to 65 having large nozzle diameters. That is, the first self-cleaning is executed before the second self-cleaning. This allows the pressures of the cleaning solutions sprayed from the assist nozzles 71 to 74 to be reduced at the time when the second valve 81 moves to the second open position, can prevent the cleaning solution from being blown up, and, as a result, can suppress the chance of the cleaning solution being adhered to the housing near the cleaning position or other cleaning nozzles.

In FIG. 8, a first external cleaning nozzle 84 and a second external cleaning nozzle 85 are provided diagonally to the side of the first cleaning unit 51 and the second cleaning unit 52. During self-cleaning and/or immediately after self-cleaning, the first external cleaning nozzle 84 sprays liquid (for example, pure water) obliquely downward toward the substrate cleaning nozzles 61 to 65, and the second external cleaning nozzle 85 sprays liquid obliquely downward toward the assist nozzles 71 to 74. This washes away the cleaning solution and the polishing slurry remaining on the surfaces of the substrate cleaning nozzles 61 to 65 and the assist nozzles 71 to 74 through self-cleaning.

Inside the housing 11, the control part 15 that controls the operation of each part of the substrate polishing apparatus 10 is disposed. The control part 15 is, for example, a general-purpose computer device, and includes a CPU, a storage part (memory) 70 that stores a control program, a display part, and the like. Additionally, the control part 15 includes an input part that receives an external input. Here, the external input may include a mechanical operation by a user, as well as the input of signals from an external device via wired or wireless communication.

The control part 15 controls the movement of each device of the substrate polishing apparatus 10 by starting the control program stored in the storage part (memory) 70. The control program for controlling the operation of the substrate polishing apparatus 10 may be installed in advance in the computer forming the control part 15, or may be stored in a storage medium such as DVD, BD, or SSD, and furthermore, may be installed in the control part 15 via the Internet.

FIG. 9 shows an example of functional blocks of the control part 15 of the substrate polishing apparatus 10. The control part 15 includes a storage part 90, a polishing control part 91, an endpoint determination part 92, a transport control part 93, and a nozzle control part 94. The polishing control part 91 controls the rotation of the polishing table 30 and the top ring 32, and also controls the pressures of the pressure chambers P1 to P5. The endpoint determination part 92 determines whether the polishing amount of the substrate W has reached a set value by using an optical sensor or the like (not shown), and terminates substrate polishing in the case where the set value has been reached. The transport control part 93 controls the transport of the substrate W within the substrate polishing apparatus 10, including the transport of the substrate W in the polishing units 13A to 13D.

The nozzle control unit 94 is connected to the atomizer 35, the substrate cleaning nozzles 61 to 65 forming the first cleaning unit 51, the assist nozzles 71 to 74 forming the second cleaning unit 52, the RR side surface cleaning nozzle 53, the RR/membrane cleaning nozzle 54, and the external cleaning nozzles 84 and 85, and controls the spraying of the cleaning solution from each nozzle.

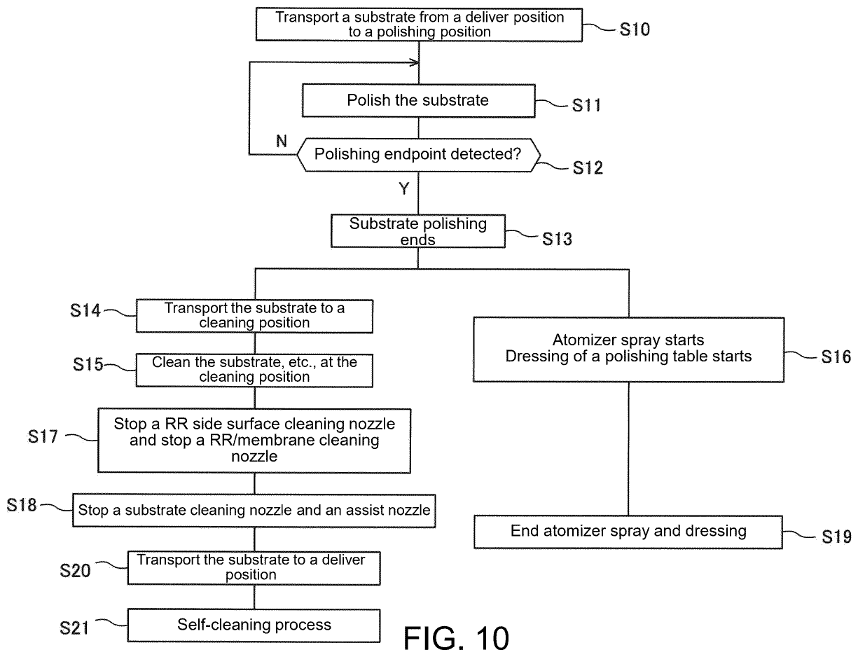

Hereinafter, the substrate polishing and post-polishing cleaning processes in the substrate polishing apparatus 10 having the configuration will be described by using the flowchart of FIG. 10. When the substrate W is transported to the polishing unit 13A, the top ring 32 holds the substrate W at a position surrounded by the retainer ring 39 through vacuum suction, and transports the substrate W from the deliver position TP2 to the polishing position TP1 (Step S10). The polishing unit 13A performs the polishing process on the substrate W by pressing the substrate W that has reached the polishing position TP1 against the polishing pad 31 (Step S11). During substrate polishing, the measurement of the film thickness of the substrate W is performed, whether a predetermined film thickness has been reached (whether a polishing endpoint has been reached) is determined (Step S12), and in the case where the polishing endpoint has been reached, the substrate polishing is terminated (Step S13).

Thereafter, the top ring 32 holding the substrate W is moved to the cleaning position TP3 (Step S14). When the substrate W and the top ring 32 reach the cleaning position TP3, various nozzles (including the first nozzle 81 and the second nozzle 82) forming the auxiliary cleaning part 50 are driven while the top ring 32 is rotated, and the cleaning process of the substrate W, the top ring 32, and the retainer ring 39 is performed (Step S15). Accordingly, particles adhering to the substrate W, the top ring 32, and the retainer ring 39 due to substrate polishing are discharged to the outside.

Here, in the substrate cleaning nozzles 61 to 65 that are two-fluid nozzles, the longitudinal direction of the sprayed cleaning solutions 61a to 65a is inclined with respect to the rotation direction of the substrate W. At this time, most of the cleaning solutions 61a to 65a sprayed from the substrate cleaning nozzles flow toward the downstream side (radial outer peripheral direction), and a portion of the cleaning solutions 61a to 65a flows toward the upstream side (radial center direction). Since the liquid flow of the cleaning solutions 61a to 65a toward the downstream side (radial outer peripheral direction) is fast, the cleaning solution containing particles can be efficiently discharged to the outer periphery. Also, with respect to the rotation direction of the substrate W, the assist nozzles 71 to 74 are disposed downstream of the substrate cleaning nozzles 61 to 65 and are inclined toward the substrate cleaning nozzles 61 to 65. The cleaning solutions sprayed from the assist nozzles 71 to 74 facilitate the flow of the cleaning solution from the substrate cleaning nozzles 61 to 65 toward the outer peripheral portion of the substrate W, and the cleaning solution containing particles can be efficiently discharged to the outside of the substrate W.

In parallel with Step S14 above, the atomizer 35 is driven to spray the cleaning solution onto the polishing pad 30, and the dresser 34 is driven to start dressing of the polishing pad 31 (Step S16). Accordingly, the cleaning process of the substrate W held by the top ring 32 and the dressing process of the polishing pad 31 are performed in parallel. The dressing process and the cleaning process of the polishing pad 31 are performed in parallel with the post-polishing cleaning process of the top ring 32 and the substrate W by the auxiliary cleaning part 50. After a certain time has elapsed, the RR side surface cleaning nozzle 53 and the RR/membrane cleaning nozzle 54 are stopped, and the cleaning process for the retainer ring 39 and the membrane 40 is terminated (Step S17). Thereafter, the substrate cleaning nozzles 61 to 65 and the assist nozzles 71 to 74 are stopped (Step S18). Accordingly, the post-polishing cleaning processing of the substrate W is terminated.

Then, the spray of the cleaning solution by the atomizer 35 and the dressing process of the polishing pad 30 end (Step S19). Accordingly, it is possible to eliminate the possibility that droplets containing particles from the top ring 32 remain on the polishing pad 30 due to the post-polishing cleaning processing. Then, the top ring 32 is moved to the deliver position TP2 (Step S20), and the substrate W after completion of polishing is transported toward the cleaning part 14.

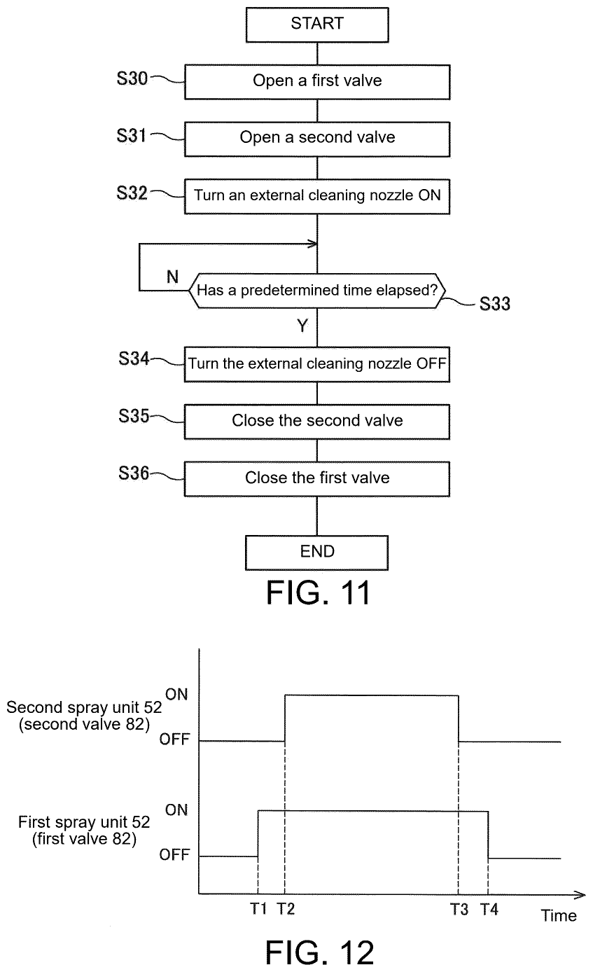

When the substrate W moves from the cleaning position TP3 to the deliver position TP2, self-cleaning for cleaning the substrate cleaning nozzles 61 to 65 and the assist nozzles 71 to 74 is performed (Step S21). FIG. 11 is a flowchart showing the processing procedure of self-cleaning, and FIG. 12 is a timing chart showing an example of ON/OFF control of the first valve 81 and the second valve 82 in self-cleaning.

In FIG. 11 and FIG. 12, when self-cleaning is started, at a time T1 (see FIG. 12), the first valve 81 corresponding to the first cleaning unit 51 is opened (Step S30). Accordingly, the cleaning solution is sprayed vertically upward from the substrate cleaning nozzles 61 to 65, and the liquid (liquid containing slurry and polishing debris) that enters the substrate cleaning nozzles 61 to 65 from the substrate W during post-polishing cleaning is removed.

Here, with the first valve 81 being closed, a predetermined pressure is generated in the piping of the cleaning solution to the first valve 81. Here, with the first valve 81 opening first, the cleaning solution is sprayed upward from the corresponding substrate cleaning nozzles 61 to 65, but since the openings of the substrate cleaning nozzles 61 to 65 have a larger area than the assist nozzles 71 to 74 and the spray pressure becomes relatively small, the cleaning solution can be prevented from being blown up.

Thereafter, at a time T2 (see FIG. 12), the second valve 82 corresponding to the second cleaning unit 52 is opened (Step S31). Accordingly, the cleaning solutions are sprayed vertically upward from the assist nozzles 71 to 74, and the liquid (liquid containing slurry and polishing debris) that enters the assist nozzles 71 to 74 from the substrate W during post-polishing cleaning is removed. At this time, the first valve 81 is already opened, and since the pressure in the piping of the cleaning solution leading to the second valve 82 is reduced, the cleaning solution from the corresponding assist nozzles 71 to 74 can be suppressed from being blown up.

Additionally, the flow controller (flow rate control device) 83 controls the flow rates of the cleaning solutions supplied to the first cleaning unit 51 and the second cleaning unit 52 in the first self-cleaning and the second self-cleaning to be smaller than the flow rate of the cleaning solution when the cleaning solution is sprayed toward the substrate W at the cleaning position. Accordingly, the cleaning solution during self-cleaning can be prevented being excessively blown up.

Thereafter, the first external cleaning nozzle 84 and the second external cleaning nozzle 85 are opened, and the cleaning solution is sprayed obliquely upward toward the substrate cleaning nozzles 61 to 65 and the assist nozzles 71 to 74 (Step S32). Accordingly, the liquid (liquid containing slurry and polishing debris) adhering to the surfaces of the substrate cleaning nozzles 61 to 65 and the assist nozzles 71 to 74 is removed.

After self-cleaning by the nozzles has elapsed for a predetermined time (Step S33: “Y”), the external cleaning nozzles 84, 85 are closed (Step S34), and at a time T3 (see FIG. 12), the second valve 82 corresponding to the second cleaning unit 52 is closed (Step S35). Next, at a time T4 (see FIG. 12), the first valve 81 corresponding to the first cleaning unit 51 is closed (Step S36), and the self-cleaning is completed.

In the above embodiment, self-cleaning is performed at the timing according to the substrate W moving from the cleaning position TP3 to the deliver position TP2, but the disclosure is not limited to the above example, and self-cleaning may be performed in the case where the substrate W is not at the cleaning position TP3 (for example, in the case where the substrate W is at the polishing position TP1, in the case where the substrate W is not set in the polishing unit).

In the above embodiment, self-cleaning is performed after the substrate cleaning process, but the disclosure is not limited to this, and may be configured to perform self-cleaning during substrate polishing or at timing before the substrate cleaning process.

In the embodiment, the configuration is provided with the external cleaning nozzles 84, 85 corresponding to each of the first cleaning unit 51 and the second cleaning unit 52, but the configuration may also be provided with a single external cleaning nozzle (third external cleaning nozzle) that performs the cleaning process for both the first cleaning unit 51 and the second cleaning unit 52.

The embodiments are described for the purpose of enabling a person having ordinary knowledge in the technical field to which the disclosure belongs to implement the disclosure. Various modification examples of the above embodiments can naturally be made by those skilled in the art, and the technical concept of the present invention can be applied to other embodiments. The disclosure is not limited to the described embodiments, but is to be interpreted in the broadest scope according to the technical concept defined by the claims.

What is claimed is:

1. A substrate cleaning apparatus that cleans a substrate at a cleaning position after the substrate is polished, the substrate cleaning apparatus comprising:
a first cleaning unit, comprising a first cleaning nozzle that sprays a cleaning solution toward the substrate that is at the cleaning position;
a second cleaning unit, comprising a second nozzle that is a second cleaning nozzle spraying a cleaning solution toward the substrate at the cleaning position and has a spray port whose diameter is smaller than a diameter of a spray port of the first cleaning nozzle;
a first valve, switching between a first open state in which the cleaning solution is sprayed from the first cleaning nozzle and a first closed state in which the cleaning solution is not sprayed from the first cleaning nozzle;
a second valve, switching between a second open state in which the cleaning solution is sprayed from the second cleaning nozzle and a second closed state in which the cleaning solution is not sprayed from the second cleaning nozzle; and
a control part, controlling the first valve and the second valve, so as to spray the cleaning solution from each of the first cleaning unit and the second cleaning unit
wherein the control part is configured to:
control an operation of the first valve, so that first self-cleaning is executed in which the cleaning solution exits from the first valve by switching the first cleaning nozzle from the first closed state to the first open state in a state where the substrate is not at the cleaning position;
control an operation of the second valve, so that second self-cleaning is executed in which the cleaning solution exits from the second valve by switching the second cleaning nozzle from the second closed state to the second open state in the state where the substrate is not at the cleaning position; and
exert control to execute the first self-cleaning prior to the second self-cleaning.

2. The substrate cleaning apparatus as claimed in claim 1, wherein the control part controls to open valves in an order of the first valve and the second valve, and controls to close valves in an order of the second valve and the first valve.

3. The substrate cleaning apparatus as claimed in claim 1, wherein a polishing surface of the substrate at the cleaning position is disposed to face downward, and the first cleaning nozzle and the second cleaning nozzle are disposed on a lower side of the substrate and spray upward the cleaning solutions.

4. The substrate cleaning apparatus as claimed in claim 1, further comprising a flow rate control device that adjusts flow rates of the cleaning solutions to the first cleaning unit and the second cleaning unit,
wherein flow rates of the cleaning solutions during the first self-cleaning and the second self-cleaning are smaller than flow rates of the cleaning solutions at a time of spraying the cleaning solutions toward the substrate at the cleaning position.

5. The substrate cleaning apparatus as claimed in claim 1, further comprising a first external cleaning nozzle that sprays a cleaning solution to the first cleaning unit.

6. The substrate cleaning apparatus as claimed in claim 1, further comprising a second external cleaning nozzle that sprays a cleaning solution to the second cleaning unit.

7. The substrate cleaning apparatus as claimed in claim 1, comprising a third external cleaning nozzle that sprays a cleaning solution to the first cleaning unit and the second cleaning unit simultaneously.

8. A substrate polishing apparatus, comprising:
a polishing table for holding a polishing pad;
a top ring for holding a substrate; and
the substrate cleaning apparatus as claimed in claim 1.

9. The substrate polishing apparatus as claimed in claim 8, wherein the second cleaning unit is disposed downstream of the first cleaning unit in a rotation direction of the top ring at the cleaning position.

10. The substrate polishing apparatus as claimed in claim 8, wherein the top ring has: a membrane having a pressing surface of the substrate; and a retainer ring located on an outer side of the substrate, and further comprises a third cleaning unit spraying a cleaning solution between the membrane and the retainer ring and/or toward the retainer ring.
